(19) United States
(12) Patent Application Publication
(10) Pub. No.: US 2026/0129632 A1
(43) Pub. Date: May 7, 2026

(54) SYSTEMS AND METHODS FOR TRANSMITTING ON MULTIPLE SOUNDING REFERENCE SIGNAL RESOURCES IN MULTIPLE TRANSMISSION/RECEPTION POINT OPERATION

(71) Applicant: ZTE CORPORATION, Shenzhen (CN)

(72) Inventors: Yang ZHANG, Shenzhen (CN); Bo GAO, Shenzhen (CN); Ke YAO, Shenzhen (CN); Xiaolong GUO, Shenzhen (CN); Meng MEI, Shenzhen (CN)

(73) Assignee: ZTE CORPORATION, Shenzhen (CN)

(21) Appl. No.: 19/439,016

(22) Filed: Jan. 2, 2026

Related U.S. Application Data
(63) Continuation of application No. PCT/CN2023/111282, filed on Aug. 4, 2023.

(51) Int. Cl. H04W 72/21; H04L 27/26; H04W 72/044

(52) U.S. Cl. CPC H04W 72/21; H04L 27/261; H04W 72/046

(57) ABSTRACT

Presented are systems and methods for transmitting on multiple sounding reference signal resources in a multiple transmission/reception point operation. A wireless communication device can determine whether the condition that the wireless communication device reports supporting simultaneous physical uplink shared channel transmissions is met. If the condition is met, the wireless communication device can then transmit simultaneous physical uplink shared channel transmissions on multiple sounding reference signal resources. The wireless communication node can receive simultaneous physical uplink shared channel transmissions on multiple sounding reference signal resources.

### CROSS-REFERENCE TO RELATED APPLICATION

This application claims the benefit of priority under 35 U.S.C. § 120 as a continuation of PCT Patent Application No. PCT/CN2023/111282, filed on Aug. 4, 2023, the disclosure of which is incorporated herein by reference in its entirety.

### TECHNICAL FIELD

The disclosure relates generally to wireless communications, including but not limited to systems and methods for transmitting on multiple sounding reference signal resources in a multiple transmission/reception point operation.

### BACKGROUND

Comprehensive coverage is a fundamental aspect of cellular network deployments. Mobile operators use various network nodes to expand coverage. New concepts like integrated access and backhaul (IAB) systems have been explored, eliminating the need for wired backhaul and improving network efficiency. Similarly, the RF repeater is another addition to supplement the coverage for 2G, 3G, and 4G networks. As the industry transitions to the 5G new radio (NR) system, the incorporation of multiple-input, multiple-output (MIMO) features and multiple transmission/reception point (MTRP) operations can further augment coverage and optimize network performance.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A wireless communication device (e.g., UE) can determine that at least one condition is satisfied/met, which includes that the wireless communication device reports supporting simultaneous (e.g., at least partial overlap or concurrency in time domain) physical uplink shared channel (PUSCH) transmissions. The wireless communication device can simultaneously transmit, in response to at least one condition being satisfied/met, on a plurality of sounding reference signal (SRS) resources that occupy a same set of one or more resources. In some implementations, the same set of one or more resources can comprise/include at least one of a resource block (RB) or a symbol. In some implementations, the wireless communication device can determine that at least one condition is satisfied/met, which can include that the wireless communication device is configured with a plurality of sets of SRS resources for codebook or non-codebook based PUSCH transmission.

In some implementations, the wireless communication device can be configured with a plurality of sets of SRS resources for codebook-based PUSCH transmissions. The wireless communication device can simultaneously transmit on only one SRS resource from each of the plurality of sets of SRS resources, or the maximum number of SRS resources on which the wireless communication device can simultaneously transmit is according to the capability reported by the wireless communication device. In certain implementations, the wireless communication device can be configured with a plurality of sets of SRS resources for codebook based PUSCH transmissions. When the wireless communication device supports simultaneous PUSCH transmissions in the spatial domain modulation (SDM) scheme, up to 2 ports can be configured to each of the SRS resources. Similarly, when the wireless communication device supports simultaneous PUSCH transmissions in single frequency network (SFN) scheme, up to 2 ports or 4 ports can be configured to each of the SRS resources. The maximum number of SRS resources on which the wireless communication device can simultaneously transmit is according to the capability reported by the wireless communication device.

In some implementations, the wireless communication device can be configured with the plurality of sets of SRS resources for non-codebook based PUSCH transmissions. The wireless communication device can simultaneously transmit on all SRS resources from the plurality of sets of SRS resources. The maximum number of SRS resources on which the wireless communication device can simultaneously transmit is according to the capability reported by the wireless communication device.

In certain implementations, the wireless communication device can be configured with the plurality of sets of SRS resources for non-codebook based PUSCH transmissions. The maximum number of SRS resources on which the wireless communication device can simultaneously transmit is smaller/less than the total number of SRS resources configured in the plurality of sets of SRS resources. This maximum number is determined by a maximum number of transmission layers of a plurality of simultaneously transmitted PUSCHs associated with the plurality of sets of SRS resources. When the wireless communication device supports simultaneous PUSCH transmissions in the spatial division multiplexing (SDM) scheme, the wireless communication device can simultaneously transmit up to 4 SRS resources. Similarly, when the wireless communication device supports simultaneous PUSCH transmissions in the single frequency network (SFN) scheme, the wireless communication device can simultaneously transmit up to 2 or 4 SRS resources. The maximum number of SRS resources on which the wireless communication device can simultaneously transmit is determined by the capability reported by the wireless communication device.

In some implementations, the wireless communication device can be configured with the plurality of sets of SRS resources for non-codebook based PUSCH transmissions. The maximum number of SRS resources from an SRS resource set on which the wireless communication device can simultaneously transmit is smaller/less than the total number of SRS resources configured in the plurality of sets of SRS resources. The maximum number of SRS resources from an SRS resource set on which the wireless communication device can simultaneously transmit is determined by the maximum number of transmission layers of the PUSCH associated with one of the plurality of sets of SRS resources. When the wireless communication device supports simultaneous PUSCH transmissions in the spatial division multiplexing (SDM) scheme, the wireless communication device can simultaneously transmit up to 2 SRS resources from the SRS resource set. Similarly, when the wireless communication device supports simultaneous PUSCH transmissions in the single frequency network (SFN) scheme, the wireless communication device can simultaneously transmit up to 2 or 4 SRS resources from the SRS resource set. The maximum number of SRS resources from the SRS resource set on which the wireless communication device can simultaneously transmit is according to the capability reported by the wireless communication device.

In certain implementations, the wireless communication device can determine that at least one condition is satisfied/met, which can include that the wireless communication device reports supporting SRS antenna switching when a number of receive antenna ports is equal to a number of transmit antenna ports, which is x. The number of transmit antenna ports of the PUSCH associated with one of the sets of SRS resources can be up to x and is according to a capability reported by the wireless communication device. The number of the plurality of sets of SRS resources for codebook or non-codebook based PUSCH transmission can be up to a number “n,” which is configured for the wireless communication device. The number of antenna ports of each SRS resource can be set to up to x. The antenna ports of each SRS resource in a given one of the sets of SRS resources can be associated with different antenna ports of the wireless communication device. Different antenna ports of the wireless communication device for an SRS resource can be used for the PUSCH associated with one of the sets of SRS resources for codebook or non-codebook based PUSCH transmission. Each SRS resource can be configured in a different one of the sets of SRS resources. Each one of the sets of SRS resources can be configured with usage set to “antennaSwitching.” The number of the plurality of sets of SRS resources can be up to a number “m,” which is configured for the wireless communication device. Each of the sets of SRS resources can be configured with the same value of the higher layer parameter resourceType set to the value of at least one of periodic, semi-persistent, or aperiodic. Power control parameters of each of the sets of SRS resources can be configured with different or independent values, or the beam state of each SRS resource can be different or independent from that of another SRS resource.

In some implementations, the wireless communication device can determine that at least one condition is satisfied/met, which can include that the wireless communication device reports supporting SRS antenna switching when the number of receive antenna ports is larger/greater than the number of transmit antenna ports, which is x. The number of transmit antenna ports of the PUSCH associated with one of the sets of SRS resources can be up to x and is according to the capability reported by the wireless communication device. The number of the plurality of sets of SRS resources for codebook or non-codebook based PUSCH transmission can be up to a number “n,” which is configured for the wireless communication device. The number of antenna ports of each SRS resource can be set to up to x. The SRS ports of each SRS resource in a given one of the sets of SRS resources can be associated with different antenna ports of the wireless communication device. Different antenna ports of the wireless communication device of an SRS resource can be used for the PUSCH associated with one of the sets of SRS resources for codebook or non-codebook based PUSCH transmission. Each SRS resource can be configured in a different one of the sets of SRS resources. Each one of the sets of SRS resources can be configured with usage set to “antennaSwitching.” The number of the plurality of sets of SRS resources can be up to a number “m,” which is configured for the wireless communication device. Each of the sets of SRS resources is configured with the same value of the higher layer parameter resourceType set to the value of at least one of periodic, semi-persistent, or aperiodic. Power control parameters of each of the sets of SRS resources can be configured with different or independent values, or a beam state of each SRS resource can be different or independent from that of another SRS resource.

In certain implementations, the wireless communication device can determine that at least one condition is satisfied/met, which can include that the wireless communication device is configured with a plurality of sets of SRS resources with usage set to “beammanagement.” Each SRS resource can be configured in a different one of the sets of SRS resources, and each of the sets of SRS resources can be configured with the same value of the higher layer parameter resourceType set to the value of at least one of periodic, semi-persistent, or aperiodic. Each of the sets of SRS resources can be configured with one or more SRS resources of 1-port, and each of the sets of SRS resources can be configured with an identifier. The identifier can comprise/include at least one of a panel identifier ID, a group ID, or a set ID. The maximum value of the identifier is equal to the value of n (where n is a positive integer value) that corresponds to the number of the configured SRS resource sets for codebook or non-codebook based PUSCH transmission. Each SRS resource can be associated with a different identifier that is configured for one of the sets of SRS resources. The SRS ports of each SRS resource in a given one of the sets of SRS resources can be associated with different antenna ports of the wireless communication device. Power control parameters of each of the sets of SRS resources can be configured with different or independent values, or the beam state of each SRS resource can be different or independent from that of another SRS resource.

At least one aspect is directed to a system, method, apparatus, or a computer-readable medium. The wireless communication node (e.g., base station) can receive simultaneous transmissions from a wireless communication device on a plurality of sounding reference signal (SRS) resources that occupy the same set of one or more resources. The simultaneous transmissions are in response to at least one condition being met/satisfied, which includes that the wireless communication device can report supporting simultaneous physical uplink shared channel (PUSCH) transmissions.

In some implementations, the wireless communication device can transmit on multiple sounding reference signal resources in a multiple transmission/reception point operation according to at least one of the following example configurations or solutions:
Example configuration 1: On SRS for codebook based PUSCH transmission, SRS from different panels can be transmitted simultaneously for uplink radio channel estimation of the subsequent PUSCH transmission.
Example configuration 2: On SRS for non-codebook based PUSCH transmission, SRS from different panels can be transmitted simultaneously for uplink radio channel estimation of the subsequent PUSCH transmission.
Example configuration 3: On SRS for DCI CSI acquisition via antenna switching, SRS transmitted from different panels on the UE side to different TRPs (transmission-reception point) on the gNB side to acquire DL CSI of the linkage between the panel and the TRP.
Example configuration 4: On SRS for beam management, it is necessary to specify that SRS can only be transmitted from different panels but not from the same panel.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a spatial domain modulation scheme-based single single downlink control information scheduled simultaneous physical uplink shared channel transmission in multiple transmission/reception point operation in a 5G NR system, in accordance with some embodiments of the present disclosure;

FIG. 4 illustrates a single frequency network scheme-based single downlink control information scheduled simultaneous physical uplink shared channel transmission in multiple transmission/reception point operation in a 5G NR system, in accordance with some embodiments of the present disclosure;

FIG. 5 illustrates the mapping of multiple sounding reference signal ports to physical antennas via a spatial filter, in accordance with some embodiments of the present disclosure;

FIG. 6 illustrates different sounding reference signal resources applied to different spatial filters per panel, in accordance with some embodiments of the present disclosure; and

FIG. 7 illustrates a flow diagram of an example method for transmitting on multiple sounding reference signal resources in a multiple transmission/reception point operation, in accordance with an embodiment of the present disclosure.

### DETAILED DESCRIPTION

In the present disclosure, the following terminologies can be used to define/interpret/clarify one or more aspects of the disclosed technology:
“Simultaneous uplink transmission scheme” includes multiple uplink transmissions that can be fully or partially overlapped in time domain, where the simultaneous uplink transmissions can be associated with different panels/TRP IDs, and these simultaneous uplink transmissions can be scheduled by a single DCI signaling or multiple DCI signalings. Besides, whether the UE supports the “simultaneous uplink transmission scheme” can be optionally reported as an UE capability.
“TRP” includes (or has a correspondence to, or is associated with) at least one of SRS resource set, spatial relation, power control parameter set, TCI state, CORESET, CORESETPoolIndex, physical cell index (PCI), sub-array, CDM group of DMRS ports, the group of CSI-RS resources, or CMR set.
“UE panel” includes (or has a correspondence to, or is associated with) at least one of UE capability value set, antenna group, antenna port group, beam group, sub-array, SRS resource set, spatial relation, the group of DMRS ports, CDM group, or panel mode.
“PUSCH antenna port index” includes (or has a correspondence to, or is associated with) uplink antenna ports starting with 0000. For example, PUSCH antenna port 0 is equivalent to uplink antenna port 0000, SRS port 1 is equivalent to uplink antenna port 0001, and so on.
“SRS port index” may refer to (or has a correspondence to, or is associated with) uplink antenna ports starting with 1000. For example, SRS port 0 is equivalent to uplink antenna port 1000, SRS port 1 is equivalent to uplink antenna port 1001, and so on.
“Beam state” includes (or has a correspondence to, or is associated with) at least one of quasi-co-location (QCL) state, transmission configuration indicator (TCI) state, spatial relation (also called spatial relation information), reference signal (RS), spatial filter, or precoding. Furthermore, in the present disclosure, “beam state” is also called “beam”. Specifically,
   “Tx beam” includes at least one of QCL state, TCI state, spatial relation state, DL reference signal, UL reference signal, Tx spatial filter, or Tx precoding.
   “Rx beam” includes at least one of QCL state, TCI state, spatial relation state, spatial filter, Rx spatial filter, or Rx precoding.
   “Beam ID” includes at least one of QCL state index, TCI state index, spatial relation state index, reference signal index, spatial filter index, or precoding index.
The spatial filter can be either UE-side or gNB-side, and the spatial filter is also called a spatial-domain filter.
“Spatial relation” is comprised of or associated with one or more reference RSs, which are used to represent the same or quasi-co “spatial relation” between the targeted “RS or channel” and the one or more reference RSs.
“Spatial relation” also means/indicates at least one of beam, spatial parameter, or spatial domain filter.
“QCL state” comprises/includes (or has a correspondence to, or is associated with) one or more reference RSs and their corresponding QCL type parameters, where QCL type parameters include at least one of the following aspects, or combinations: [1] Doppler spread, [2] Doppler shift, [3] delay spread, [4] average delay, [5] average gain, and [6] Spatial parameter (which is also called as spatial Rx parameter). “TCI state” may refer to “QCL state”. In the present disclosure, there are the following definitions/interpretations for ‘QCL-TypeA’, ‘QCL-TypeB’, ‘QCL-TypeC’, and ‘QCL-TypeD’.

‘QCL-TypeA’: {Doppler shift, Doppler spread, average delay, delay
spread}
‘QCL-TypeB’: {Doppler shift, Doppler spread}
‘QCL-TypeC’: {Doppler shift, average delay}
‘QCL-TypeD’: {Spatial Rx parameter}

A RS comprises/includes a channel state information reference signal (CSI-RS), synchronization signal block (SSB) (which is also called SS/PBCH), demodulation reference signal (DMRS), sounding reference signal (SRS), and physical random access channel (PRACH). Furthermore, the RS at least comprises DL reference signaling (RS) and UL reference signaling (RS).
   A DL RS at least comprises/includes CSI-RS, SSB, and DMRS (e.g., DL DMRS).
   A UL RS at least comprises/includes SRS, DMRS (e.g., UL DMRS), and PRACH.
“UL signal” can be/include PUCCH transmission, PUSCH transmission, or SRS.
“DL signal” can be/include PDCCH transmission, PDSCH transmission, or CSI-RS.
The first and the second SRS resource sets can respectively be the ones with lower and higher srs-ResourceSetId of the two SRS resource sets configured by the higher layer parameter srs-ResourceSetToAddModList or srs-ResourceSetToAddModListDCI-0-2, and associated with the higher layer parameter usage of value ‘nonCodeBook’ if txConfig=nonCodebook or ‘codeBook’ if xConfig-codebook.
“Uplink” includes at least one of PUSCH transmission, PUCCH transmission, SRS, or PRACH transmission.
“Downlink” includes or may refer to at least one of PDSCH transmission, PDCCH transmission, CSI-RS, SSB, or DL-PRS.
PUSCH transmission includes (or is associated with) PUSCH transmission occasion.
The TPMI field in DCI includes at least one of the precoding information and number of layers field in DCI, or the second precoding information field in DCI.
The SRI field in DCI includes at least one of the SRS resource indicator field in DCI or the second SRS resource indicator field in DCI.
DCI includes at least one of DCI format 01, DCI format 0_2, or DCI format 0_0.

### 1. Mobile Communication Technology and Environment

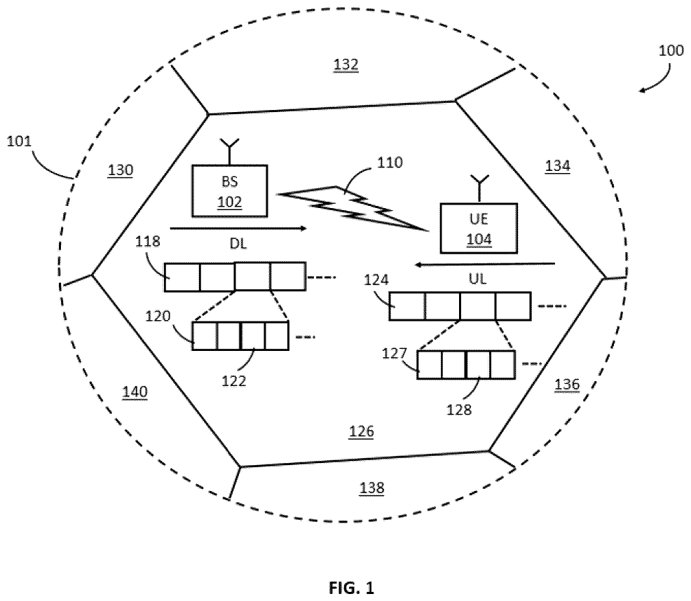

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

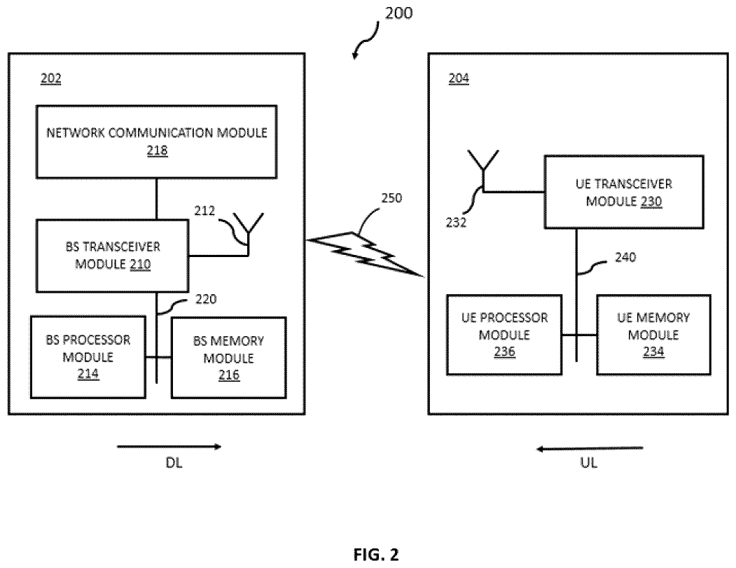

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communicate with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Transmitting Multiple Sounding Reference Signal (SRS) Resources in Multiple Transmission/Reception Point (TRP) Operation

The current 5G new radio (NR) system supports multiple transmission/reception point (MTRP) operation for uplink (UL) transmissions. However, due to the restrictions of the current UE capability, multiple uplink transmissions can only be performed as non-overlapped in time domain. As a result, the UE can only transmit one uplink transmission at a time, even if it is equipped with multiple antenna panels. This restriction limits the reliability and throughput of UL transmissions. For example, if the UE wants to transmit multiple signals, it may have to transmit the signals one after the other in the time domain. This can lead to delays and reduce the accuracy of the channel state information (CSI) measurements.

To overcome this limitation, the solution is to allow the UE to simultaneously transmit multiple uplink transmissions. As detailed herein, the current specification focuses on enabling multiple SRS transmission. The SRS transmission signal is an important uplink reference signal that can be used for different purposes, such as codebook-based and non-codebook-based physical uplink shared channel (PUSCH) transmission, antenna switching, beam management, and uplink positioning. This would enable the UE to transmit data from different antenna panels at the same time, thereby improving the accuracy of the CSI measurements and reducing delays.

5G NR includes a number of MIMO (multiple-input, multiple-output) features that facilitate the utilization of a large number of antenna elements at the base station for both sub-6 GHz (Frequency Range 1, FR1) and over-6 GHz (Frequency Range 2, FR2) frequency bands. One of these features is multi-TRP operation, which allows the base station to collaborate with multiple TRPs to transmit or receive data to the UE. This can improve transmission performance by increasing diversity and spatial multiplexing gains.

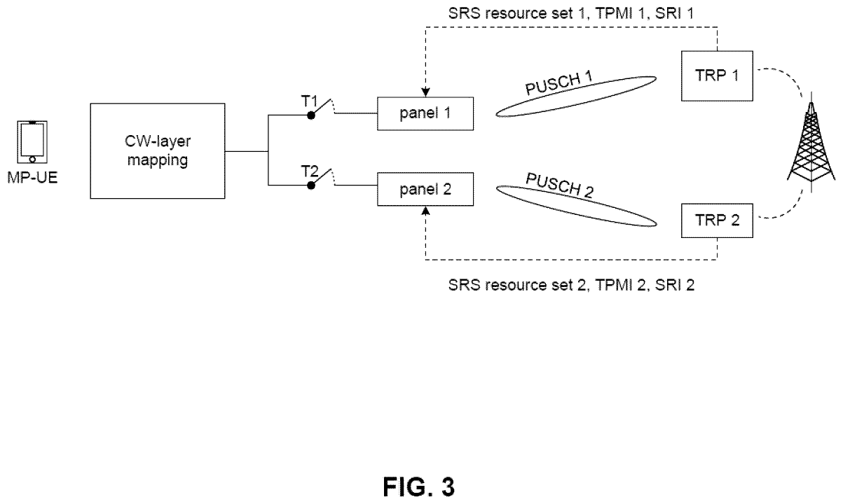

Referring now to FIG. 3, the illustration depicts the spatial domain modulation (SDM) scheme-based single downlink control information (DCI) scheduled simultaneous PUSCH transmission in MTRP operation in a 5G NR system. As shown, in MTRP operation, the UE can transmit multiple layers of the PUSCH to different TRPs and separately associate them with different SRS resource sets (e.g., SRS resource set 1, SRS resource set 2, etc.). The precoder, rank, and selected SRS resource(s) of the PUSCH transmitted from each panel are indicated by the first and second TPMI/SRI fields, respectively. For example, in FIG. 3, the UE transmits a layer of PUSCH 1 to TRP 1 and a layer of PUSCH 2 to TRP 2. The precoder, rank, and selected SRS resource(s) of the PUSCH transmitted from panel 1 are indicated by the first TPMI/SRI field, while the precoder, rank, and selected SRS resource(s) of the PUSCH transmitted from panel 2 are indicated by the second TPMI/SRI field. When the UE switches to single transmission reception point (STRP) operation (e.g., either T1 or T2 is closed), PUSCH transmission from one panel can be associated with one SRS resource set. The precoder, rank, and selected SRS resource(s) of the PUSCH transmitted from one panel are indicated by the first or second TPMI/SRI field.

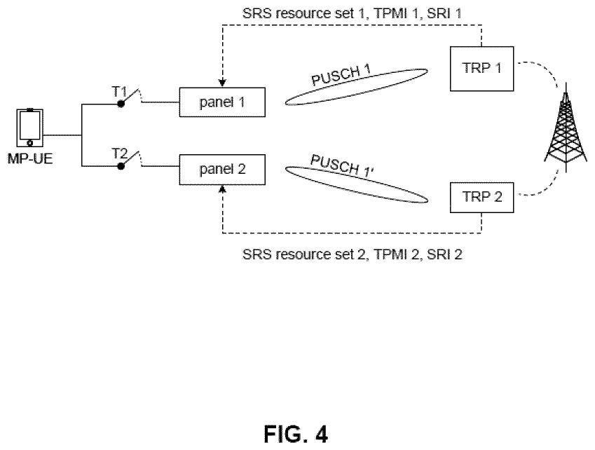

Referring now to FIG. 4, the illustration depicts the single frequency network (SFN) scheme-based single DCI scheduled simultaneous PUSCH transmission in MTRP operation in a 5G NR system. In MTRP operation, all of the same layers/DMRS ports of one PUSCH are transmitted from different UE panels and towards different TRPs simultaneously. These PUSCH transmissions are associated with different SRS resource sets, where the precoder, rank, and selected SRS resource(s) of each PUSCH transmission from each panel are indicated by the first and second TPMI/SRI fields. For example, as shown in FIG. 4, the UE transmits a layer of PUSCH 1 to TRP 1 and a layer of PUSCH 1′ to TRP 2. The precoder, rank, and selected SRS resource(s) of the PUSCH transmitted from panel 1 are indicated by the first TPMI/SRI field, while the precoder, rank, and selected SRS resource(s) of the PUSCH transmitted from panel 2 are indicated by the second TPMI/SRI field. When the UE switches to STRP operation, PUSCH transmission from one panel may be associated with one SRS resource set, and the precoder, rank, and selected SRS resource(s) of the PUSCH transmitted from one panel can be indicated by the first or second TPMI/SRI field.

In wireless communication systems, SRS can be configured/provided for different transmission modes: periodic, semi-persistent, or aperiodic transmission. A periodic SRS is transmitted at regular intervals following a certain configured periodicity and slot offset within that periodicity. Similarly, a semi-persistent SRS follows a similar configuration as a periodic SRS but its actual transmission is activated and deactivated through MAC CE signaling/protocol. On the other hand, an aperiodic SRS is only transmitted when explicitly triggered by means of DCI. In particular, DCI format 0-1 (uplink scheduling grant) and DCI format 1-1 (downlink scheduling assignment) include a 2-bit SRS-request field that can trigger the transmission of one out of three different aperiodic SRS resource sets configured for the UE.

The UE can be configured with one or multiple SRS resource sets, where each set comprises/includes one or more configured SRS. All SRS within a configured SRS resource set are of the same type, either periodic, semi-persistent, or aperiodic in terms of transmission. For codebook-based PUSCH transmission, the number of configured SRS resources in an SRS resource set depends on the UE capability. Specifically, a maximum of 2 or 4 SRS resources can be configured with the usage set to ‘codebook’. Similarly, for non-codebook-based PUSCH transmission, subject to UE capability, an SRS resource set can accommodate a maximum of 4 SRS resources with the usage set to ‘nonCodebook’. For SRS used for DL CSI acquisition through antenna switching, subject to UE capability, at least 1 SRS resource can be configured within an SRS resource set with the usage set to ‘antennaSwitching’. Similarly, for SRS used for beam management, subject to UE capability, at least 1 SRS resource can be configured within an SRS resource set with the usage set to ‘beamManagement’.

The UE antenna switching capability for SRS transmission in 5G NR can be indicated by ‘xTyR’. In particular, ‘xTyR’ indicates/signifies that the UE possesses the capability (or is configured) to transmit SRS signals through ‘x’ antenna ports, using a total of ‘y’ antennas for this purpose. The value of ‘y’ corresponds to either all or a subset of the receive antennas present in the UE's configuration. When the UE transmits SRS on multiple antenna ports, the different ports can share the same set of resource elements and the same basic SRS sequence. The antenna ports may be numbered in a specific way, with different ranges of numbers being used for different purposes. For example, uplink antenna ports starting with 0000 are used for PUSCH associated with DMRS, while uplink antenna ports starting with 1000 are used for SRS.

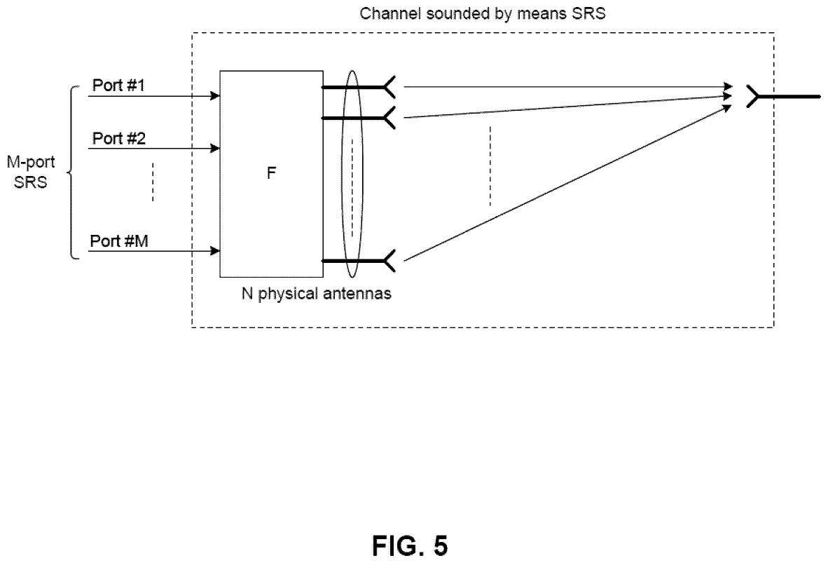

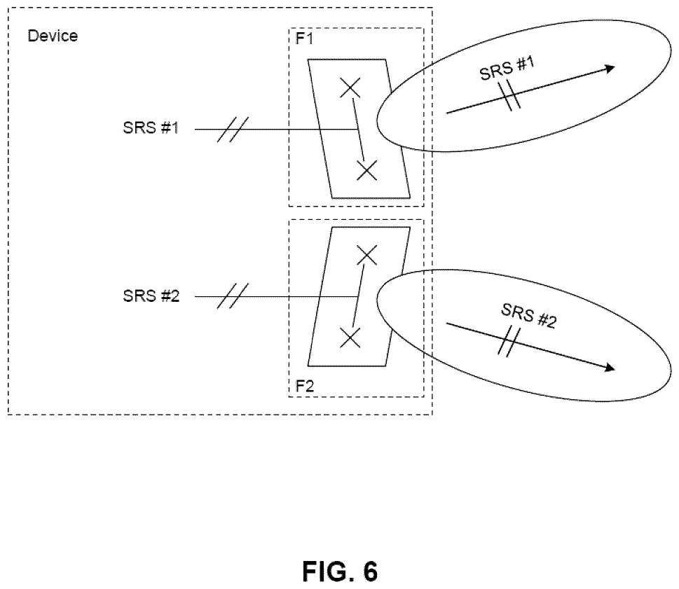

In the context of SRS transmission, the utilization of multiple SRS ports (M-SRS ports) involves mapping. For example, rather than being directly linked to the physical antennas of the device, SRS ports can be subjected to a spatial filter, F. The spatial filtering F facilitates the mapping of M-SRS ports to N physical antennas, as illustrated in FIG. 5. As shown, the mapping process exemplifies a transformation, where SRS antenna ports are converted to a set of physical antennas, allowing for optimized transmission. Transmission from different panels within the system can correspond to distinct spatial filters F, as illustrated in FIG. 6.

In certain example implementations, simultaneous transmission of SRS can be enabled for codebook based PUSCH if at least one of the specific conditions is satisfied/met. The first condition is the reporting of UE capability, indicating support for simultaneous PUSCH transmission. This capability can be triggered by a single DCI for PUSCH transmitted in an SDM or SFN scheme. The condition may involve multi-DCI triggering, allowing/enabling more than one PUSCH to be transmitted in the same time domain. Once the UE identifies the satisfaction of at least one condition, the UE may respond by simultaneously transmitting on multiple SRS resources. These SRS resources can occupy the same set of one or more specific resources to ensure coordinated SRS transmission.

The second condition can include the configuration of the UE with multiple SRS resource sets dedicated to codebook based PUSCH transmission. These SRS resource sets can be configured within designated parameters, such as srs-ResourceSetToAddModList or srs-ResourceSetToAddModListDCI-0-2. Each SRS resource set can be configured/provided with the usage set to ‘codebook’ to configure the relevance of each SRS resource set to codebook based PUSCH transmission. The UE can verify that the condition is satisfied/met by confirming the presence of multiple sets of SRS resources configured for codebook based PUSCH transmission. The third condition for codebook based uplink transmission is directed to the maximum number of SRS resources that can be configured per SRS resource set. The value of this maximum number can be configured as at least one of 1, 2, or 4. The fourth condition includes the configuration of the SRS port for each individual SRS resource. The ability to set the SRS port to values like 1, 2, 4, or 8 can enhance adaptability, e.g., for supporting simultaneous transmissions.

In certain configurations, the UE may transmit more than one SRS resource from multiple SRS resource sets simultaneously. In some implementations, one SRS resource (e.g., only one SRS resource) from each SRS resource set can be transmitted simultaneously. This simultaneous transmission can occur when the UE reports that the UE (e.g., wireless communication device) supports simultaneous PUSCH transmissions. These SRS resource sets are configured to occupy the same Resource Blocks (RBs) and/or symbols. For example, if two SRS resource sets are configured, then up to two SRS resources from these two SRS resource sets can be transmitted simultaneously. As detailed herein, the maximum number of SRS resources that can be transmitted simultaneously is subject to UE capability.

In certain configurations, the specific port configuration depends on the UE capability. For example, if the UE reports to support simultaneous PUSCH transmission in the SDM scheme, up to two ports can be configured/provided for each SRS resource. Similarly, if the UE reports to support simultaneous PUSCH transmission in the SFN scheme, up to two or four ports can be configured for each SRS resource. The maximum number of SRS resources that can be transmitted simultaneously is subject to UE capability.

In certain example implementations, simultaneous transmission of SRS can be enabled for non-codebook based PUSCH if at least one of the specific conditions is satisfied/met. The first condition is the reporting of UE capability, indicating support for simultaneous PUSCH transmission. This capability may involve a single DCI triggering PUSCH transmitted in an SDM or SFN scheme, or multi-DCI triggering more than one PUSCH that is transmitted in the same time domain. The second condition includes the configuration of the UE with multiple SRS resource sets dedicated to non-codebook based PUSCH transmission. These SRS resource sets are configured/provided within designated parameters, such as srs-ResourceSetToAddModList or srs-ResourceSetToAddModListDCI-0-2. Each SRS resource set can be configured with the usage set to ‘nonCodebook’ to configure the relevance of each SRS resource set to non-codebook based PUSCH transmission. The UE can verify that the condition is satisfied/met by confirming the presence of multiple sets of SRS resources configured for non-codebook based PUSCH transmission. The third condition for non-codebook based uplink transmission is directed to the maximum number of SRS resources that can be configured per SRS resource set. The value of this maximum number can be configured as at least one of 1, 2, 3, or 4. The maximum number of SRS resources that can be transmitted simultaneously is subject to UE capability. The UE capability can be indicated by the parameter maxNumberSRS-ResourceTx. The fourth condition includes the configuration of one SRS port for each individual SRS resource.

In certain configurations, the UE may transmit more than one SRS resource from multiple SRS resource sets simultaneously. In some implementations, one SRS resource (e.g., only one SRS resource) from each SRS resource set can be transmitted simultaneously. This simultaneous transmission can occur when the UE reports that it supports simultaneous PUSCH transmissions. These SRS resource sets are configured to occupy the same RBs and/or symbols. For example, if four SRS resources are configured in each of two SRS resource sets, then eight SRS resources can be transmitted simultaneously. As detailed herein, the maximum number of SRS resources that can be transmitted simultaneously is subject to UE capability. For example, the UE capability can be indicated by the parameters maxNumberSRS-ResourceTx or maxNumberSRS-ResourceTxAcrossMulti-Sets.

In certain configurations, UE may transmit more than one SRS resource from multiple SRS resource sets simultaneously. In some implementations, one SRS resource (e.g., only one SRS resource) from each SRS resource set can be transmitted simultaneously. This simultaneous transmission can occur when the UE reports that it supports simultaneous PUSCH transmissions. These SRS resource sets are configured to occupy the same RBs and/or symbols. The maximum number of SRS resources that can be transmitted simultaneously can be less/smaller than the total number of SRS resources configured in multiple SRS resource sets. For example, four SRS resources can be configured in each of two SRS resource sets, but the maximum number of SRS resources that can be transmitted simultaneously is four. In some implementations, the maximum number of SRS resources that can be transmitted simultaneously can be determined by the maximum number of transmission layers of all simultaneously transmitted PUSCHs associated with more than one configured SRS resource set.

If the UE reports (e.g., sends a report to the BS or wireless communica node) to support simultaneous PUSCH transmission in the SDM scheme, then up to four SRS resources can be used for simultaneous transmissions. Similarly, if the UE reports to support simultaneous PUSCH transmission in the SFN scheme, then up to two or four SRS resources can be used for this. As detailed herein, the maximum number of SRS resources that can be used for simultaneous transmissions is subject to UE capability. For example, the UE capability can be indicated by the parameters maxNumberSRS-ResourceTx or maxNumberSRS-ResourceTxAcrossMulti-Sets.

In certain configurations, UE may transmit on/using more than one SRS resource from multiple SRS resource sets simultaneously. In some implementations, one SRS resource (e.g., only one SRS resource) from each SRS resource set can be used for simultaneous transmissions. This simultaneous transmission can occur when the UE reports that it supports simultaneous PUSCH transmissions. These SRS resource sets are configured to occupy the same RBs and/or symbols. The maximum number of SRS resources used for simultaneous transmissions from each SRS resource set can be less than the total number of SRS resources configured in each SRS resource set. For example, if four SRS resources are configured in each of two SRS resource sets, then the maximum number of SRS resources that can be transmitted simultaneously from each SRS resource set is two. In some implementations, the maximum number of SRS resources that can be used for simultaneous transmissions from each SRS resource can be determined by the maximum number of transmission layers of PUSCH associated with one configured SRS resource set. For example, if the maximum number of transmission layers of PUSCH associated with one SRS resource set is two, then the maximum number of SRS resources from that SRS resource set is also two.

If the UE reports to support simultaneous PUSCH transmission in the SDM scheme, then up to two SRS resources from one SRS resource set can be used for simultaneous transmissions. Similarly, if the UE reports to support simultaneous PUSCH transmission in the SFN scheme, then up to two or four SRS resources from one SRS resource set can be used for simultaneous transmissions. As detailed herein, the maximum number of SRS resources from an SRS resource set that can be used for simultaneous transmissions is subject to UE capability. For example, the UE capability can be indicated by the parameters maxNumberSRS-ResourceTx or maxNumberSRS-ResourceTxofOne-Set.

In certain example implementations, simultaneous transmission of SRS for DL CSI acquisition via xT=xR antenna switching can be enabled if at least one of the specific conditions is satisfied/met. The first condition is the reporting of UE capability, indicating support for simultaneous PUSCH transmission. This capability may involve a single DCI triggering PUSCH transmitted in an SDM or SFN scheme, or multi-DCI triggering more than one PUSCH that is transmitted in the same time domain. The second condition includes the configuration of the UE with multiple (n) SRS resource sets (where, n>1) for codebook or non-codebook based PUSCH transmission. Each SRS resource set can be configured/provided with a usage set of either “codebook” or “nonCodebook.” The number of transmit antenna ports of PUSCH that are associated with an SRS resource set can be up to x, which is subject to UE capability reporting. The value of x can be 1, 2, 4, or 8. The third condition is the UE reporting its capability to support SRS antenna switching for the case where the number of receive antenna ports is equal to the number of transmit antenna ports. The reported value can be at least one of 1T=1R, 2T=2R, 4T=4R, or 8T=8R.

In certain configurations, the UE can transmit on more than one SRS resource that occupies the same symbol(s) and/or RB(s) for DL CSI acquisition. The number of antenna ports of each SRS resource can be set to up to x. For example, if the value of x is set to 1, it is used for the case of 1T=1R based SRS antenna switching corresponding to an SRS resource set. Similarly, if the value of x is set to 2, it is used for the case of 2T=2R based SRS antenna switching corresponding to an SRS resource set. Similarly, if the value of x is set to 4, it is used for the case of 4T=4R based SRS antenna switching corresponding to an SRS resource set. Similarly, if the value of x is set to 8, it is used for the case of 8T=8R based SRS antenna switching corresponding to an SRS resource set.

In certain configurations, the antenna port(s) of each SRS resource in a given set can be associated with different UE antenna port(s). Different UE antenna port(s) of an SRS resource can be used for PUSCH that is associated with an SRS resource set.
a) For a first example, in the case of 1T=1R based SRS antenna switching, antenna port 1000 of a first 1-port SRS in an SRS resource set can be associated with antenna port 0000 of PUSCH that is associated with a first SRS resource set. Similarly, antenna port 1001 of a second 1-port SRS in another SRS resource set can be associated with antenna port 0001 of PUSCH that is associated with a second SRS resource set.
b) For a second example, in the case of 2T=2R based SRS antenna switching, antenna ports 1000-1001 of a first 2-port SRS in an SRS resource set can be associated with antenna ports 0000-0001 of PUSCH that are associated with a first SRS resource set. Similarly, antenna ports 1002-1003 of a second 2-port SRS in another SRS resource set can be associated with antenna ports 0002-0003 of PUSCH that are associated with a second SRS resource set.
c) For a third example, in the case of 4T=4R based SRS antenna switching, antenna ports 1000-1003 of a first 4-port SRS in an SRS resource set can be associated with antenna ports 0000-0003 of PUSCH that are associated with a first SRS resource set. Similarly, antenna ports 1004-1007 of a second 4-port SRS in another SRS resource set can be associated with antenna ports 0004-0007 of PUSCH that are associated with a second SRS resource set, respectively.
d) For a fourth example, in the case of 8T=8R based SRS antenna switching, antenna ports 1000-1007 of a first 8-port SRS in an SRS resource set can be associated with antenna ports 0000-0007 of PUSCH that are associated with a first SRS resource set. Similarly, antenna ports 1008-1015 of a second 8-port SRS in another SRS resource set can be associated with antenna ports 0008-0015 of PUSCH that are associated with a second SRS resource set.
e) For a first example, in the case of 1T=1R based SRS antenna switching, antenna port 1000 of a first 1-port SRS in an SRS resource set can be associated with antenna port 0000 of PUSCH that is associated with a first SRS resource set. Similarly, antenna port 1000 of a second 1-port SRS in another SRS resource set can be associated with antenna port 0001 of PUSCH that is associated with a second SRS resource set.
f) For a second example, in the case of 2T=2R based SRS antenna switching, antenna ports 1000-1001 of a first 2-port SRS in an SRS resource set can be associated with antenna ports 0000-0001 of PUSCH that are associated with a first SRS resource set. Similarly, antenna ports 1000-1001 of a second 2-port SRS in another SRS resource set can be associated with antenna ports 0002-0003 of PUSCH that are associated with a second SRS resource set.
g) For a third example, in the case of 4T=4R based SRS antenna switching, antenna ports 1000-1003 of a first 4-port SRS in an SRS resource set can be associated with antenna ports 0000-0003 of PUSCH that are associated with a first SRS resource set. Similarly, antenna ports 1000-1003 of a second 4-port SRS in another SRS resource set can be associated with antenna ports 0004-0007 of PUSCH that are associated with a second SRS resource set.
h) For a fourth example, in the case of 8T=8R based SRS antenna switching, antenna ports 1000-1007 of a first 8-port SRS in an SRS resource set can be associated with antenna ports 0000-0007 of PUSCH that are associated with a first SRS resource set. Similarly, antenna ports 1000-1007 of a second 8-port SRS in another SRS resource set can be associated with antenna ports 0008-0015 of PUSCH that are associated with a second SRS resource set.

In certain configurations, each SRS resource can be configured in different SRS resource sets. Each SRS resource set can be configured with a usage set of ‘antennaSwitching’. The number of SRS resource sets can be up to ‘m’, where the value of m is equal to the value of n that corresponds to the number of the configured SRS resource sets for codebook or non-codebook based PUSCH transmission. Each SRS resource set can be configured with the same value of higher layer parameter resourceType, which can be set to at least one of “periodic,” “semi-persistent,” or “aperiodic.” In certain configurations, the power control parameters of each SRS resource set can be configured with different/independent values. The power control parameters can include at least one of alpha, p0, pathlossReferenceRS, or srs-PowerControlAdjustmentStates. The beam state of each SRS resource can be different/independent. The beam state can be configured by spatialRelationInfo or srs-TCI-State.

In certain example implementations, simultaneous transmission of SRS for DL CSI acquisition via xTyR antenna switching can be enabled if at least one of the specific conditions is satisfied/met. The first condition is the reporting of UE capability, indicating support for simultaneous PUSCH transmission. This capability may involve a single DCI triggering PUSCH transmitted in an SDM or SFN scheme, or multi-DCI triggering more than one PUSCH that is transmitted in the same time domain. The second condition includes the configuration of the UE with multiple (n) SRS resource sets (where, n>1) for codebook or non-codebook based PUSCH transmission. Each SRS resource set can be configured with a usage set of either “codebook” or “nonCodebook.” The number of transmit antenna ports of PUSCH that is associated with an SRS resource set can be up to x, which is subject to UE capability reporting. The value of x can be 1, 2, or 4. The third condition is the UE reporting its capability to support SRS antenna switching for the case where the number of receive antenna ports is greater than the number of transmit antenna ports. The reported value can be at least one of 1T2R, 1T4R, 1T6R, 1T8R, 2T4R, 2T6R, 2T8R, or 4T8R.

In certain configurations, the UE can transmit on more than one SRS resource that occupies the same symbol(s) and/or RB(s) for DL CSI acquisition. The number of antenna ports of each SRS resource can be set to up to x. For example, if the value of x is set to 1, it is used for the case of 1T2R, 1T4R, 1T6R, or 1T8R based SRS antenna switching corresponding to an SRS resource set. Similarly, if the value of x is set to 2, it is used for the case of 2T4R, 2T6R or 2T8R based SRS antenna switching corresponding to an SRS resource set. Similarly, if the value of x is set to 4, it is used for the case of 4T8R based SRS antenna switching corresponding to an SRS resource set.

In certain configurations, the antenna port(s) of each SRS resource in a given set can be associated with different UE antenna port(s). Different UE antenna port(s) of an SRS resource can be used for PUSCH that is associated with an SRS resource set.
a) For a first example, in the case of 1T2R, 1T4R, 1T6R, or 1T8R based SRS antenna switching, antenna port 1000 of a first 1-port SRS in an SRS resource set can be associated with antenna port 0000 of PUSCH that is associated with a first SRS resource set. Similarly, antenna port 1001 of a second 1-port SRS in another SRS resource set can be associated with antenna port 0001 of PUSCH that is associated with a second SRS resource set.
b) For a second example, in the case of 2T4R, 2T6R or 2T8R based SRS antenna switching, antenna ports 1000-1001 of a first 2-port SRS in an SRS resource set can be associated with antenna ports 0000-0001 of PUSCH that are associated with a first SRS resource set. Similarly, antenna ports 1002-1003 of a second 2-port SRS in another SRS resource set can be associated with antenna ports 0002-0003 of PUSCH that are associated with a second SRS resource set.
c) For a third example, in the case of 4T8R based SRS antenna switching, antenna ports 1000-1003 of a first 4-port SRS in an SRS resource set can be associated with antenna ports 0000-0003 of PUSCH that are associated with a first SRS resource set. Similarly, antenna ports 1004-1007 of a second 4-port SRS in another SRS resource set can be associated with antenna ports 0004-0007 of PUSCH that are associated with a second SRS resource set.
d) For a first example, in the case of 1T2R, 1T4R, 1T6R, or 1T8R based SRS antenna switching, antenna port 1000 of a first 1-port SRS in an SRS resource set can be associated with antenna port 0000 of PUSCH that is associated with a first SRS resource set. Similarly, antenna port 1000 of a second 1-port SRS in another SRS resource set can be associated with antenna port 0001 of PUSCH that is associated with a second SRS resource set.
e) For a second example, in the case of 2T4R, 2T6R, or 2T8R based SRS antenna switching, antenna ports 1000-1001 of a first 2-port SRS in an SRS resource set can be associated with antenna ports 0000-0001 of PUSCH that are associated with a first SRS resource set. Similarly, antenna ports 1000-1001 of a second 2-port SRS in another SRS resource set can be associated with antenna ports 0002-0003 of PUSCH that are associated with a second SRS resource set.
f) For a third example, in the case of 4T8R based SRS antenna switching, antenna ports 1000-1003 of a first 4-port SRS in an SRS resource set can be associated with antenna ports 0000-0003 of PUSCH that are associated with a first SRS resource set. Similarly, antenna ports 1000-1003 of a second 4-port SRS in another SRS resource set can be associated with antenna ports 0004-0007 of PUSCH that are associated with a second SRS resource set.

In certain configurations, each SRS resource can be configured into different SRS resource sets. Each SRS resource set can be configured/provided with a usage set of ‘antennaSwitching’. The number of SRS resource sets can be up to ‘m’, where the value of m is equal to the value of n that corresponding to the number of the configured SRS resource sets for codebook or non-codebook based PUSCH transmission. Each SRS resource set can be configured with the same value of the higher layer parameter resourceType, which can be set to at least one of “periodic,” “semi-persistent,” or “aperiodic.” In certain configurations, the power control parameters of each SRS resource set can be configured with different/independent values. The power control parameters can include at least one of alpha, p0, pathlossReferenceRS, or srs-PowerControlAdjustmentStates. The beam state of each SRS resource can be different/independent. The beam state can be configured by spatialRelationInfo or srs-TCI-State.

In certain example implementations, simultaneous transmission of SRS for beam management can be enabled if at least one of the specific conditions is satisfied/met. The first condition is the reporting of UE capability, indicating support for simultaneous PUSCH transmission. This capability may involve a single DCI triggering PUSCH transmitted in an SDM or SFN scheme, or multi-DCI triggering more than one PUSCH that is transmitted in the same time domain. The second condition includes the configuration of the UE with multiple resource sets with a usage set of ‘beamManagement’. One SRS resource in each of multiple SRS resource sets can be transmitted at a given time instant, and 1-port SRS resource(s) can be configured in each of multiple SRS resource sets. The third condition includes the configuration of the UE with multiple (n) SRS resource sets (where, n>1) for codebook or non-codebook based PUSCH transmission. Each SRS resource set can be configured with a usage set of either “codebook” or “nonCodebook.” The number of transmit antenna ports of PUSCH that is associated with an SRS resource set can be up to x, which is subject to UE capability reporting. The value of x can be 1, 2, or 4.

In certain configurations, the UE can transmit on more than one SRS resource that occupies the same symbol(s) and/or RB(s) for beam management. Each SRS resource can be configured in different SRS resource sets. The UE can be configured with m SRS resource sets with a usage set of ‘beamManagement’. Each SRS resource set can be configured with the same value of the higher layer parameter resourceType, which can be set to at least one of “periodic,” “semi-persistent,” or “aperiodic.” 1-port SRS resource(s) can be configured in each of multiple SRS resource sets, and each SRS resource set can be configured with a unique identifier. The identifier can be at least one of a panel ID, a group ID, or a set ID. The maximum value of the identifier is equal to the value of n (n is a positive integer value) that corresponds to the number of the configured SRS resource sets for codebook or non-codebook based PUSCH transmission. Each SRS resource is associated with a different identifier that can be configured for the SRS resource set. The SRS port(s) of each SRS resource in a given set are associated with a different UE antenna port(s). The UE antenna ports can be used for a PUSCH transmission that is associated with an SRS resource set. The power control parameters can include at least one of alpha, p0, pathlossReferenceRS, or srs-PowerControlAdjustmentStates. The beam state of each SRS resource can be different/independent. The beam state can be configured by spatialRelationInfo or srs-TCI-State.

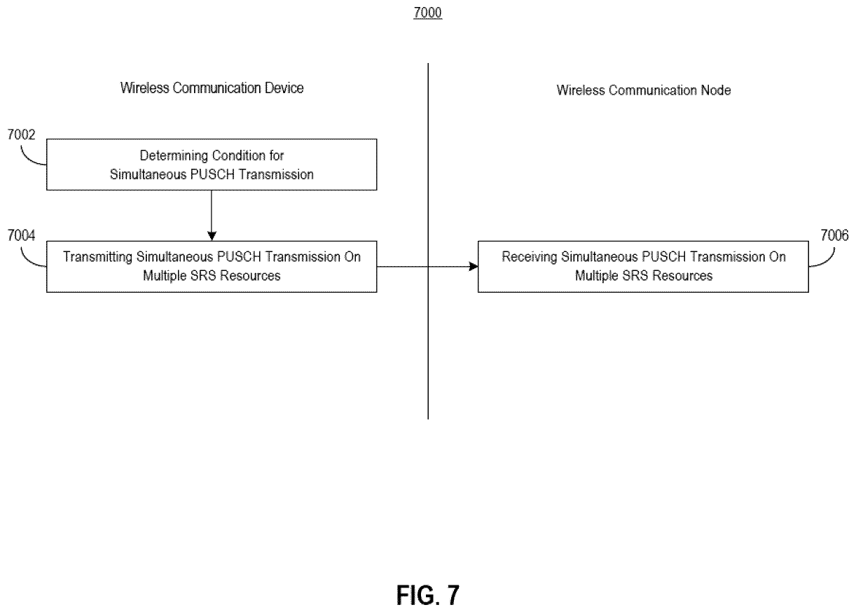

Referring now to FIG. 7 illustrates a flow diagram of a method 7000 for transmitting on multiple (e.g., a plurality of) sounding reference signal (SRS) resources in a multiple transmission/reception point (TRP) operation. The method 7000 may be implemented using any of the components and devices detailed herein in conjunction with FIGS. 1-6. In an overview, the method 7000 may include determining/configuring whether the condition that the wireless communication device (e.g., UE) reports supporting simultaneous physical uplink shared channel (PUSCH) transmissions is satisfied/met (7002). If the condition is satisfied/met, the method can include transmitting/sending simultaneous PUSCH transmission on multiple SRS resources to the wireless communication node (e.g., base station, via multiple TRPs) (7004). The method can also include receiving simultaneous PUSCH transmission on multiple SRS resources (7006), e.g., by the wireless communication node from the wireless communication device (e.g., via a plurality of TRPs).

At operation (7002), and in some arrangements, a wireless communication device (e.g., UE) can determine that at least one condition is satisfied/met, which includes that the wireless communication device supports (or is capable of) simultaneous physical uplink shared channel (PUSCH) transmissions, and/or reports supporting simultaneous PUSCH transmissions. The wireless communication device can simultaneously transmit, in response to at least one condition being satisfied/met, on a plurality of sounding reference signal (SRS) resources that occupy a same set of one or more resources (e.g., in the time domain). In certain configurations, the same set of one or more resources can comprise/include at least one of a resource block (RB) or a symbol. In some configurations, the wireless communication device can determine that at least one condition is satisfied/met, which may include that the wireless communication device is configured with a plurality of sets of SRS resources for codebook or non-codebook based PUSCH transmission.

In certain configurations, the wireless communication device can be configured with a plurality of sets of SRS resources for codebook based PUSCH transmissions. As detailed herein, simultaneous transmission of SRS can be enabled for codebook based PUSCH if at least one of the specific conditions is satisfied/met. A first condition can include the reporting of UE capability (to the wireless communication node), indicating support for simultaneous PUSCH transmissions. This capability can be triggered by a single DCI for PUSCH transmissions transmitted in an SDM or SFN scheme. The condition may involve multi-DCI triggering, allowing/enabling more than one PUSCH transmission to be transmitted in the same time domain. Once the UE identifies the satisfaction of at least one condition, the UE may respond by simultaneously transmitting on multiple SRS resources. These SRS resources can occupy the same set of one or more specific resources to ensure coordinated/simultaneous SRS/PUSCH transmissions. A second condition can include the configuration of the UE with multiple SRS resource sets dedicated to codebook based PUSCH transmission. These SRS resource sets can be configured within designated parameters, such as srs-ResourceSetToAddModList or srs-ResourceSetToAddModListDCI-0-2. Each SRS resource set can be configured/provided with the usage set to ‘codebook’ to configure the relevance of each SRS resource set to codebook based PUSCH transmission. The UE can verify that the condition is satisfied/met by confirming the presence of multiple sets of SRS resources configured for codebook based PUSCH transmission. A third condition for codebook based uplink transmission may be directed to the maximum number of SRS resources that can be configured per SRS resource set. The value of this maximum number can be configured as at least one of 1, 2, or 4. A fourth condition can include the configuration of a number of SRS port(s) for each individual SRS resource. The ability to set the number of SRS port(s) to values like 1, 2, 4, or 8 can enhance adaptability, e.g., to support simultaneous transmissions.

In some configurations, the wireless communication device can be configured with a plurality of sets of SRS resources for codebook based PUSCH transmissions. When the wireless communication device supports simultaneous PUSCH transmissions in the spatial domain modulation (SDM) scheme, up to 2 ports (e.g., 2 SRS ports to 2 antenna ports) can be configured to each of the SRS resources. Similarly, when the wireless communication device supports simultaneous PUSCH transmissions in the single frequency network (SFN) scheme, up to 2 ports or 4 ports can be configured to each of the SRS resources. The maximum number of SRS resources on which the wireless communication device can simultaneously transmit is according to the capability reported by the wireless communication device.

In certain configurations, the wireless communication device can be configured with the plurality of sets of SRS resources for non-codebook based PUSCH transmissions. As detailed herein, simultaneous transmission of SRS can be enabled for non-codebook based PUSCH if at least one of the specific conditions is satisfied/met. A first condition can include the reporting/presence of UE capability, indicating support for simultaneous PUSCH transmission. This capability may involve a single DCI triggering PUSCH transmissions transmitted in an SDM or SFN scheme, or multi-DCI triggering more than one PUSCH transmission that is transmitted in the same time domain. A second condition can include the configuration of the UE with multiple SRS resource sets dedicated to non-codebook based PUSCH transmission. These SRS resource sets can be configured/provided within designated parameters, such as srs-ResourceSetToAddModList or srs-ResourceSetToAddModListDCI-0-2. Each SRS resource set can be configured with the usage set to ‘nonCodebook’ to configure the relevance of each SRS resource set to non-codebook based PUSCH transmission. The UE can verify that the condition is satisfied/met by confirming the presence of multiple sets of SRS resources configured for non-codebook based PUSCH transmission. A third condition for non-codebook based uplink transmission may be directed to the maximum number of SRS resources that can be configured per SRS resource set. The value of this maximum number can be configured as at least one of 1, 2, 3, or 4. The maximum number of SRS resources that can be transmitted simultaneously is subject to UE capability. The UE capability can be indicated by the parameter maxNumberSRS-ResourceTx. A fourth condition can include the configuration of one SRS port for each individual SRS resource.

In some configurations, the wireless communication device can be configured with the plurality of sets of SRS resources for non-codebook based PUSCH transmissions. The maximum number of SRS resources on which the wireless communication device can simultaneously transmit is smaller/less than the total number of SRS resources configured in the plurality of sets of SRS resources. This maximum number is determined by a maximum number of transmission layers of a plurality of simultaneously transmitted PUSCHs associated with the plurality of sets of SRS resources. When the wireless communication device supports simultaneous PUSCH transmissions in the spatial division multiplexing (SDM) scheme, the wireless communication device can simultaneously transmit on/using up to 4 SRS resources. Similarly, when the wireless communication device supports simultaneous PUSCH transmissions in the single frequency network (SFN) scheme, the wireless communication device can simultaneously transmit on/using up to 2 or 4 SRS resources. The maximum number of SRS resources on which the wireless communication device can simultaneously transmit on may be determined by the capability reported by the wireless communication device.

In certain configurations, the wireless communication device can be configured with the plurality of sets of SRS resources for non-codebook based PUSCH transmissions. The maximum number of SRS resources from an SRS resource set on which the wireless communication device can simultaneously transmit is smaller/less than the total number of SRS resources configured in the plurality of sets of SRS resources. The maximum number of SRS resources from an SRS resource set on which the wireless communication device can simultaneously transmit is determined by the maximum number of transmission layers of the PUSCH associated with one of the plurality of sets of SRS resources. When the wireless communication device supports simultaneous PUSCH transmissions in the spatial division multiplexing (SDM) scheme, the wireless communication device can simultaneously transmit up to 2 SRS resources from the SRS resource set. Similarly, when the wireless communication device supports simultaneous PUSCH transmissions in the single frequency network (SFN) scheme, the wireless communication device can simultaneously transmit up to 2 or 4 SRS resources from the SRS resource set. The maximum number of SRS resources from the SRS resource set on which the wireless communication device can simultaneously transmit is according to the capability reported by the wireless communication device.

In some configurations, the wireless communication device can determine that at least one condition is satisfied/met, which can include that the wireless communication device reports supporting SRS antenna switching when a number of receive antenna ports is equal to a number of transmit antenna ports, which is x (e.g., a positive integer value). The number of transmit antenna ports of the PUSCH associated with one of the sets of SRS resources can be up to x and is according to a capability reported by the wireless communication device. The number of the plurality of sets of SRS resources for codebook or non-codebook based PUSCH transmission can be up to a number “n” (where, n>1, and is an integer value), which is configured for the wireless communication device. The number of antenna ports of each SRS resource can be set to up to x. The antenna ports of each SRS resource in a given one of the sets of SRS resources can be associated with different antenna ports of the wireless communication device. Different antenna ports of the wireless communication device for an SRS resource can be used for the PUSCH associated with one of the sets of SRS resources for codebook or non-codebook based PUSCH transmission. Each SRS resource can be configured in a different one of the sets of SRS resources. Each one of the sets of SRS resources can be configured with usage set to “antennaSwitching.” The number of the plurality of sets of SRS resources can be up to a number “m” (e.g., a positive integer value), which is configured for the wireless communication device, and the value of m is equal to the value of n that corresponds to the number of the configured SRS resource sets for codebook or non-codebook based PUSCH transmission. Each of the sets of SRS resources can be configured with the same value of the higher layer parameter resource Type set to the value of at least one of periodic, semi-persistent, or aperiodic. Power control parameters of each of the sets of SRS resources can be configured with different or independent values, or the beam state of each SRS resource can be different or independent from that of another SRS resource.

In certain configurations, the wireless communication device can determine that at least one condition is satisfied/met, which can include that the wireless communication device reports supporting SRS antenna switching when the number of receive antenna ports is larger/greater than the number of transmit antenna ports, which is x. The number of transmit antenna ports of the PUSCH associated with one of the sets of SRS resources can be up to x and is according to the capability reported by the wireless communication device. The number of the plurality of sets of SRS resources for codebook or non-codebook based PUSCH transmission can be up to a number “n” (where, n>1), which is configured for the wireless communication device. The number of antenna ports of each SRS resource can be set to up to x. The SRS ports of each SRS resource in a given one of the sets of SRS resources can be associated with different antenna ports of the wireless communication device. Different antenna ports of the wireless communication device of an SRS resource can be used for the PUSCH associated with one of the sets of SRS resources for codebook or non-codebook based PUSCH transmission. Each SRS resource can be configured in a different one of the sets of SRS resources. Each one of the sets of SRS resources can be configured with usage set to “antennaSwitching.” The number of the plurality of sets of SRS resources can be up to a number “m”, which is configured for the wireless communication device, and the value of m is equal to the value of n that corresponds to the number of the configured SRS resource sets for codebook or non-codebook based PUSCH transmission. Each of the sets of SRS resources is configured with the same value of the higher layer parameter resourceType set to the value of at least one of periodic, semi-persistent, or aperiodic. Power control parameters of each of the sets of SRS resources can be configured with different or independent values, or a beam state of each SRS resource can be different or independent from that of another SRS resource.

In some implementations, the wireless communication device can determine that at least one condition is satisfied/met, which can include that the wireless communication device is configured with a plurality of sets of SRS resources with usage set to “beammanagement.” Each SRS resource can be configured in a different one of the sets of SRS resources, and each of the sets of SRS resources can be configured with the same value of the higher layer parameter resourceType set to the value of at least one of periodic, semi-persistent, or aperiodic. Each of the sets of SRS resources can be configured with one or more SRS resources of 1-port, and each of the sets of SRS resources can be configured with an identifier. The identifier can comprise/include at least one of a panel identifier ID, a group ID, or a set ID. The maximum value of the identifier is equal to the value of n (where n is a positive integer value) that corresponds to the number of the configured SRS resource sets for codebook or non-codebook based PUSCH transmission. Each SRS resource can be associated with a different identifier that is configured for one of the sets of SRS resources. The SRS ports of each SRS resource in a given one of the sets of SRS resources can be associated with different antenna ports of the wireless communication device. Power control parameters of each of the sets of SRS resources can be configured with different or independent values, or the beam state of each SRS resource can be different or independent from that of another SRS resource.

In certain configurations, the wireless communication node (e.g., base station) can receive simultaneous transmissions from a wireless communication device on a plurality of SRS resources that occupy the same set of one or more resources. The simultaneous transmissions can be in response to at least one condition being met/satisfied, which includes that the wireless communication device can report supporting simultaneous PUSCH transmissions.

While various embodiments of the present solution have been described above, it should be understood that they have been presented by way of example only, and not by way of limitation. Likewise, the various diagrams may depict an example architecture or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, which may be referenced in the above description, can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
determining, by a wireless communication device, that at least one condition is met, which includes that the wireless communication device reports supporting simultaneous physical uplink shared channel (PUSCH) transmissions; and
simultaneously transmitting, by the wireless communication device in response to the at least one condition being met, on a plurality of sounding reference signal (SRS) resources that occupy a same set of one or more resources.

2. The method of claim 1, comprising:
determining, by the wireless communication device, that the at least one condition is met, which further includes that the wireless communication device is configured with a plurality of sets of SRS resources for codebook or non-codebook based PUSCH transmission.

3. The method of claim 1, wherein the same set of one or more resources comprises at least one of: at least one resource block (RB) or at least one symbol.

4. The method of claim 2, wherein at least one of:
the wireless communication device is configured with the plurality of sets of SRS resources, for codebook based PUSCH transmissions; or
the wireless communication device simultaneously transmits on only one SRS resource from each of the plurality of sets of SRS resources.

5. The method of claim 2, wherein at least one of:
the wireless communication device is configured with the plurality of sets of SRS resources, for codebook based PUSCH transmissions;
when the wireless communication device supports simultaneous PUSCH transmissions in spatial domain modulation (SDM) scheme, up to 2 ports are configured to each of the SRS resources;
when the wireless communication device supports simultaneous PUSCH transmissions in single frequency network (SFN) scheme, up to 2 ports or 4 ports are configured to each of the SRS resources; or
a maximum number of SRS resources on which the wireless communication device can simultaneously transmit, is according to a capability reported by the wireless communication device.

6. The method of claim 2, wherein at least one of:
the wireless communication device is configured with the plurality of sets of SRS resources, for non-codebook based PUSCH transmissions;
the wireless communication device can simultaneously transmit on all SRS resources from the plurality of sets of SRS resources; or
a maximum number of SRS resources on which the wireless communication device can simultaneously transmit, is according to a capability reported by the wireless communication device.

7. The method of claim 2, wherein at least one of:
the wireless communication device is configured with the plurality of sets of SRS resources, for non-codebook based PUSCH transmissions or
the maximum number of SRS resources on which the wireless communication device can simultaneously transmit, is according to a capability reported by the wireless communication device.

8. The method of claim 2, wherein at least one of:
the wireless communication device is configured with the plurality of sets of SRS resources, for non-codebook based PUSCH transmissions; or
the maximum number of SRS resources from the SRS resource set on which the wireless communication device can simultaneously transmit, is according to a capability reported by the wireless communication device.

9. The method of claim 2, wherein the wireless communication device's capability to support simultaneous PUSCH transmissions involves receiving a downlink control information (DCI) signaling triggering PUSCH transmission in spatial domain modulation (SDM) scheme or single frequency network (SFN) scheme.

10. The method of claim 2, wherein each of the sets of SRS resources is configured with usage set to ‘nonCodebook’.

11. The method of claim 1, wherein the at least one condition includes configuration of one SRS port for each of the SRS resources.

12. A wireless communication device comprising:
at least one processor configured to:
determine that at least one condition is met, which includes that the wireless communication device reports supporting simultaneous physical uplink shared channel (PUSCH) transmissions; and
simultaneously transmit, via at least one transmitter in response to the at least one condition being met, on a plurality of sounding reference signal (SRS) resources that occupy a same set of one or more resources.

13. The wireless communication device of claim 12, wherein meeting the at least one condition further includes that the wireless communication device is configured with a plurality of sets of SRS resources for codebook or non-codebook based PUSCH transmission.

14. The wireless communication device of claim 12, wherein the same set of one or more resources comprises at least one of: at least one resource block (RB) or at least one symbol.

15. The wireless communication device of claim 13, wherein at least one of:
the wireless communication device is configured with the plurality of sets of SRS resources, for codebook based PUSCH transmissions; or
the wireless communication device simultaneously transmits on only one SRS resource from each of the plurality of sets of SRS resources.

16. The wireless communication device of claim 13, wherein at least one of:
the wireless communication device is configured with the plurality of sets of SRS resources, for codebook based PUSCH transmissions;
when the wireless communication device supports simultaneous PUSCH transmissions in spatial domain modulation (SDM) scheme, up to 2 ports are configured to each of the SRS resources;
when the wireless communication device supports simultaneous PUSCH transmissions in single frequency network (SFN) scheme, up to 2 ports or 4 ports are configured to each of the SRS resources; or
a maximum number of SRS resources on which the wireless communication device can simultaneously transmit, is according to a capability reported by the wireless communication device.

17. The wireless communication device of claim 13, wherein at least one of:
the wireless communication device is configured with the plurality of sets of SRS resources, for non-codebook based PUSCH transmissions;
the wireless communication device can simultaneously transmit on all SRS resources from the plurality of sets of SRS resources; or
a maximum number of SRS resources on which the wireless communication device can simultaneously transmit, is according to a capability reported by the wireless communication device.

18. The wireless communication device of claim 13, wherein at least one of:
the wireless communication device is configured with the plurality of sets of SRS resources, for non-codebook based PUSCH transmissions or
the maximum number of SRS resources on which the wireless communication device can simultaneously transmit, is according to a capability reported by the wireless communication device.

19. A method comprising:
receiving, by a wireless communication node, simultaneous transmissions from a wireless communication device, on a plurality of sounding reference signal (SRS) resources that occupy a same set of one or more resources,
wherein the simultaneous transmissions are in response to at least one condition being met, which includes that the wireless communication device reports supporting simultaneous physical uplink shared channel (PUSCH) transmissions.

20. A wireless communication node comprising:
at least one processor configured to:
receive, via at least one receiver, simultaneous transmissions from a wireless communication device, on a plurality of sounding reference signal (SRS) resources that occupy a same set of one or more resources,
wherein the simultaneous transmissions are in response to at least one condition being met, which includes that the wireless communication device reports supporting simultaneous physical uplink shared channel (PUSCH) transmissions.
